(19) United States
(12) Patent Application Publication
(10) Pub. No.: US 2015/0068337 A1
(43) Pub. Date: Mar. 12, 2015

(54) INTERNAL COMBUSTION ENGINE

(71) Applicants: Irek Abudarovich Galeev, Chelyabinsk (RU); Damir Abudarovich Galeev, Chelyabinsk (RU)

(72) Inventors: Irek Abudarovich Galeev, Chelyabinsk (RU); Damir Abudarovich Galeev, Chelyabinsk (RU)

(21) Appl. No.: 14/391,704

(22) PCT Filed: Apr. 13, 2012
(86) PCT No.: PCT/RU2012/000285

§ 371 Date: Oct. 13, 2014

(51) Int. Cl. F02B 67/04; F16H 1/06; F02B 41/00

(52) U.S. Cl. CPC F02B 67/04; F02B 41/00; F16H 1/06
USPC 74/414

(57) ABSTRACT

The engine comprises a cylinder with a piston arranged therein, said piston being connected to a connecting rod, and a crankshaft. A first elliptical gearwheel is rigidly fixed to the shaft with the possibility of interacting with a second elliptical gearwheel, which is rigidly fixed to an additional shaft. The distance from the pitch points of the wheel with the wheel to the axis of rotation of the wheel in the case of positions of the crankshaft corresponding to the location of the piston in the upper and lower dead points is 1.1-5 times the distance from the pitch points and to the axis of rotation of the wheel. The distance from the pitch points of the wheel with the wheel to the axis of rotation of the wheel in the case of positions of the crankshaft corresponding to the location of the piston in the centre of its excursion is 0.2-0.9 times the distance from the pitch points to the axis of rotation of the second wheel. The technical result consists in reducing the angular velocity of the crankshaft during movement of the piston in the region of the upper and lower dead points.

### CROSS-REFERENCE TO RELATED APPLICATION

This application is a national stage patent application arising from PCT/RU2012/000285 filed on Apr. 13, 2012, and referenced in WIPO Publication No. WO2013/154453. The earliest priority date claimed is Apr. 13, 2012.

### FEDERALLY SPONSORED RESEARCH

None

### SEQUENCE LISTING OR PROGRAM

None

### BACKGROUND

The present invention relates to the field of mechanical engineering, in particular, to piston internal combustion engines, and mostly, to diesel engines. The claimed piston internal combustion engine can operate, among others, on the following types of fuel:
liquids: gasoline, diesel fuel, alcohols, biodiesel;
gases: liquefied gas, natural gas, hydrogen, gaseous cracked petroleum products, biogas;
carbon monoxide produced by solid fuel combustion (such as coal, peat, or wood) in a gas generator of the engine fuel system.

A piston internal combustion engine design is known in the art and described in a textbook (Internal Combustion Engines: Design and Function of Piston and Combination Engines”), edited by A. S. Orlin, M. G. Kruglova, published by [symbol] , 1990, p.p. 5, 6, FIG. 1,a.

Said engine comprises a cylinder having a cover (head); a piston arranged therein and attached to a connecting rod; a crankshaft; and intake and exhaust valves.

A disadvantage of the known internal combustion engine is the relative inefficiency thereof due to the insufficient time to complete fuel combustion, effective removal of exhaust gases, and an air/fuel mixture intake into the cylinder. Said insufficient time is caused by the angular velocity of the crankshaft in the internal combustion engine reaching 700 radian per second, and thus allowing an extremely short time, thousandths of a second, to complete some processes, with the most important thereof occurring when the piston passes through the top and bottom dead centres.

The objective of the present invention is to improve the efficiency of an internal combustion engine. The technical result to satisfy said objective is achieved by reducing the angular velocity of the crankshaft during the piston's movement at the top and bottom dead centres, and increasing the angular velocity of the crankshaft during the piston's movement at mid-stroke.

The present invention relates to an internal combustion engine comprising a cylinder with a piston attached to a connecting rod arranged therein and a crankshaft equipped with two non-circular gear wheels; wherein, the first gear wheel is rigidly fixed on the crankshaft, and the second gear wheel, engageable with the first gear wheel, is rigidly fixed on an additional shaft in such a way that when the crankshaft's positions correspond to the piston's position at the top and bottom dead centres, the distance between the pitch points of the first and second gear wheels and the rotation axis of the first gear wheel is 1.1-5 of the distance between these pitch points and the rotation axis of the second gear wheel; while, when the crankshaft's positions correspond to the piston's mid-stroke, the distance between the pitch points of the first and second gear wheels and the rotation axis of the first gear wheel is 0.2-0.9 of the distance between these pitch points and the rotation axis of the second gear wheel.

In some embodiments, the non-circular gear wheels are elliptic. In other embodiments, the non-circular gear wheels are oval.

### SUMMARY

Two non-circular gear wheels are introduced into an internal combustion engine; wherein the first gear wheel is rigidly fixed on the crankshaft, and the second gear wheel, engageable with the first gear wheel, is rigidly fixed on an additional shaft in such a way that when the crankshaft's positions correspond to the piston's position at the top and bottom dead centres, the distance between the pitch points of the first and second gear wheels and the rotation axis of the first gear wheel is 1.1-5 of the distance between these pitch points and the rotation axis of the second gear wheel; while, when the crankshaft's positions correspond to the piston's mid-stroke, the distance between the pitch points of the first and second gear wheels and the rotation axis of the first gear wheel is 0.2-0.9 of the distance between these pitch points and the rotation axis of the second gear wheel. This reduces the angular velocity of the crankshaft during the piston's movement at the top and bottom dead centres and increases the angular velocity of the crankshaft during the piston's movement at the mid-stroke.

Said introduction increases the time of the piston's movement at the top and bottom dead centres, thereby creating optimal temporal conditions for full fuel combustion, release of exhaust gases, and intake of the air/fuel mixture into the cylinder, and thus improving the efficiency of the internal combustion engine.

Said non-circular gear wheels can be made elliptic. Said non-circular gear wheels can be made oval.

The proposed essential combination of features provides the claimed engine with novel features enabling the achievement of the set objective.

The internal combustion engine of the present invention is novel compared to the prior art and differs from the known solution in that:
said engine comprises two non-circular gear wheels, wherein the first gear wheel is rigidly fixed on the crankshaft, and the second gear wheel, engageable with the first gear wheel, is rigidly fixed on an additional shaft in such a way that when the crankshaft's positions correspond to the piston's position at the top and bottom dead centres, the distance between the pitch points of the first and second gear wheels and the rotation axis of the first gear wheel is 1.1.-5 of the distance between these pitch points and the rotation axis of the second gear wheel; while when the crankshaft's positions correspond to the piston's mid-stroke, the distance between the pitch points of the first and second gear wheels and the rotation axis of the first gear wheel is 0.2-0.9 of the distance between these pitch points and the rotation axis of the second gear wheel.
said non-circular gear wheels can be made elliptic ,
said non-circular gear wheels can be made oval.

The present invention can be widely used in mechanical engineering, in particular, in piston internal combustion engines; thus it meets the “industrial applicability” requirement.

The inventor is not aware of the existence of any internal combustion engines that possess the aforementioned essential distinctive features, which would explicitly lead to the achievement of the same technical result; said result does not clearly follow from the examined prior art, and thus, the inventor believes that the claimed invention meets the “inventive step” requirements.

### DRAWINGS

The claimed internal combustion engine is further illustrated by drawings of a two-stroke gasoline-powered engine as an example, wherein:

FIG. 1: Perspective view of the internal combustion engine with a partial cutaway at the piston's position at the top dead centre.

FIG. 2: Perspective view of the internal combustion engine with a partial cutaway at the piston's position at the bottom dead centre

FIG. 3: Perspective view of the internal combustion engine with a partial cutaway at the piston's mid-stroke movement toward the bottom dead centre.

FIG. 4: Main view of the internal combustion engine with a partial cutaway at the piston's mid-stroke movement toward the top dead centre.

### DESCRIPTION

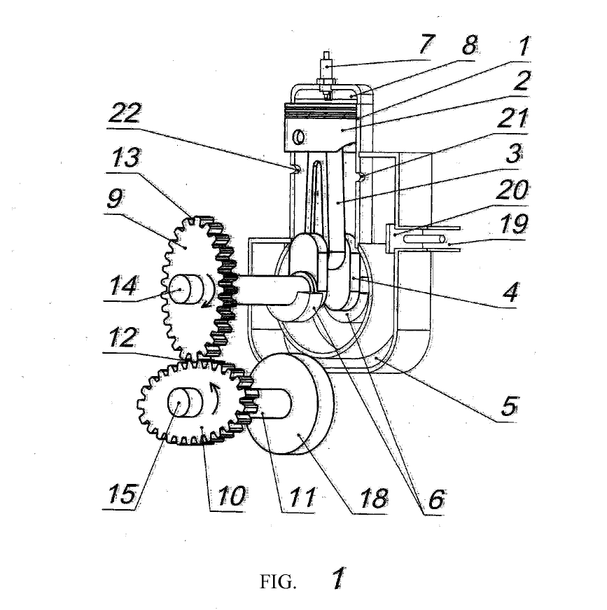

The internal combustion engine represented in the drawings (see FIGS. 1-4) comprises cylinder 1 with piston 2 arranged therein, said piston connected to connecting rod 3; crankshaft 4 arranged in crank chamber 5 and rotatable in bearings 6; and spark plug 7 with electrodes arranged in combustion chamber 8.

First oval gear wheel 9 engageable with second oval gear wheel 10, which is rigidly fixed on additional shaft 11, is rigidly fixed on crankshaft 4. Shaft 11 is arranged in rotation bearings (not shown on drawings) to be co-rotatable with gear wheel 10.

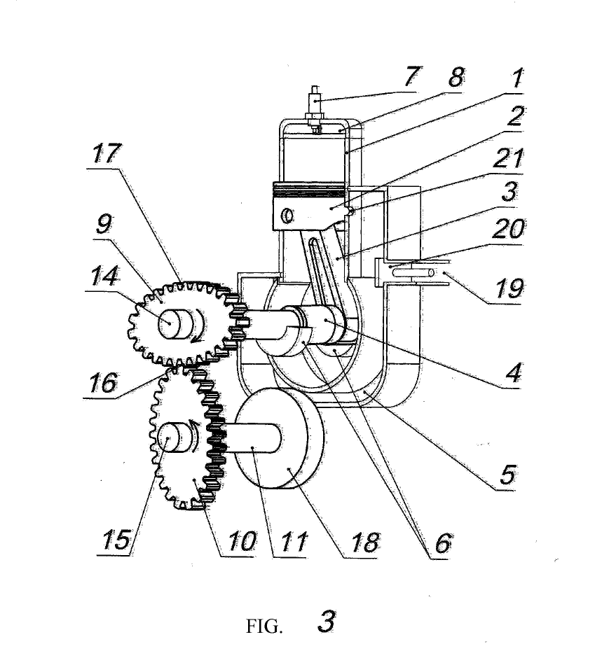

Non-circular gear wheels 9 and 10 can be made oval, elliptical, or in the shape of Diphylleia. See Mechanisms. Handbook edited by S. N. Kozhevnikova et al', M, published by Mechanical Engineering, 1976, p. 159, FIG. 3.28) and as other types of gear wheels.

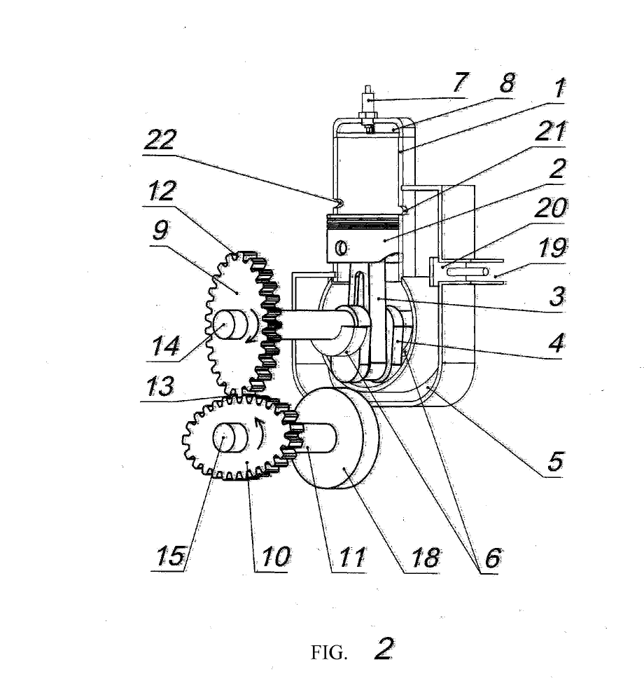

The distance between pitch points 12 and 13 of first and second gear wheels 9 and 10 (see FIGS. 1 and 2) and rotation axis 14 of first gear wheel 9 at the times when crankshaft 4 is in positions corresponding to piston's 2 positions at the top and bottom dead centres, is 2.0 of the distance between pitch points 12 and 13 and axis 15 of rotation of gear wheel 10.

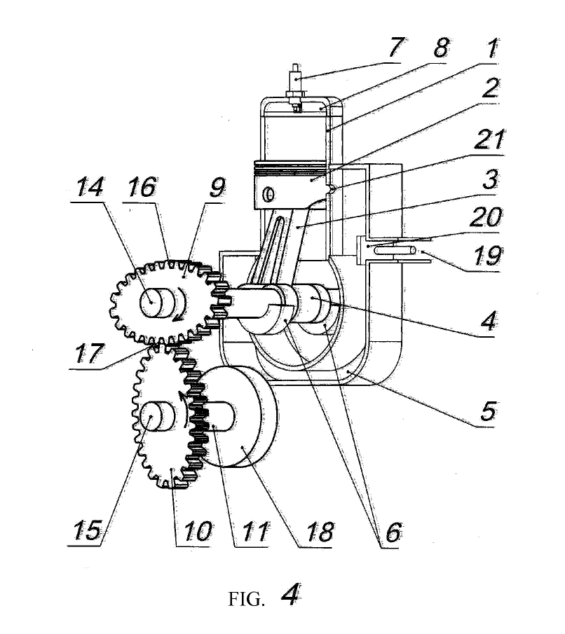

The distance between pitch points 16 and 17 of first and second gear wheels 9 and 10 (see FIGS. 3 and 4) and rotation axis 14 of first gear wheel 9 at the times when crankshaft 4 is in positions corresponding to piston's 2 positions in mid-stroke, is 0.5 of the distance between pitch points 16 and 17 and axis 15 of rotation of gear wheel 10

The ratio of distances between pitch points 12 and 13 and rotation axis 14 of first gear wheel 9 at the times when crankshaft 4 is in positions corresponding to piston's 2 positions at the top and bottom dead centres, can be 1.1-5.0 of the distance between pitch points 12 and 13 and axis of rotation 15 of gear wheel 10; and the ratio of distances between pitch points 16 and 17 and rotation axis 14 of first gear wheel 9 at the times when crankshaft 4 is in positions corresponding to piston's 2 positions in mid-stroke, can be 0.2-0.9 of the distance between pitch points 16 and 17 and axis 15 of rotation of gear wheel 10, which leads to the achievement of the desired technical result.

In the present embodiment, additional shaft 11 is a power takeoff shaft equipped with flywheel 18. Intake of the air/fuel mixture is realized via intake port 19 equipped with valve 20 and admission port 21; exhaust gases are released via exhaust port 22.

Rotational direction of gear wheels 9 and 10 is indicated on FIG. 1-4 with arrows.

The engine comprises other parts and elements known to those skilled in the art, including but not limited to the following: pumps, a cooler, electric wiring, an electric ignition system and other parts required for the engine's mechanical action (not shown). The present invention discloses only the design features necessary for understanding the spirit of the invention.

The internal combustion engine of the present invention operates as follows:

The engine's work cycle starts with a compression stroke, wherein crankshaft 4 is at the 180° position (see FIG. 2). At the same time, piston 2 is in the bottom dead centre, first gear wheel 9 is engaged with second gear wheel 10 at pitch point 13. Flywheel's 18 angular velocity is ω.

During the operation of the internal combustion engine, the load inertia, which includes a flywheel, transmission mechanisms, etc., is higher than the moment of inertia of the crankshaft, connecting rod, and piston; thus relative fluctuations of flywheel's 18 angular velocity are insignificant; additional shaft 11, within the limits of one revolution, essentially rotates at constant angular velocity.

The inertial energy of the flywheel 18 propels piston 2 from the bottom dead centre to the top dead centre, first overlapping admission port 21, and then exhaust port 22.

The scavenging process is completed when piston 2 moves into the bottom dead centre, wherein the angular velocity of first gear wheel 9 is about half the angular velocity of second gear wheel 10 because the ratio of the distance between pitch point 13 and axis of rotation 14 of first gear wheel 9 to the distance between pitch point 13 and axis of rotation 15 of second gear wheel 10 is about 2.0. That increases the time piston 2 spends in the bottom dead centre, which favorably impacts the exhaust of gases and charging of cylinder 1 with the air/fuel mixture.

Upon closing exhaust port 22 in cylinder 1 with piston 2, exhaust of gases with the air/fuel mixture and charging of cylinder 1 with the air/fuel mixture is completed and compression of the air/fuel mixture therein begins.

Compression of the air/fuel mixture in the combustion chamber concomitantly creates vacuum under piston 2 in the air-tight crank chamber 5; said vacuum facilitates the intake of the air/fuel mixture via intake port 19 with opening valve 20 into chamber 5 to be used in the next cycle

Compression of the air/fuel mixture in combustion chamber 8 and creation of vacuum in crank chamber 5 is induced by the energy of flywheel 18, whose torque effect is transmitted via additional shaft 11 onto second gear wheel 10 and therefrom, onto first gear wheel 9, and then onto piston 2 via crankshaft 4 and connecting rod 3.

When piston 2 reaches the top dead centre (see FIG. 1), first gear wheel 9 is engaged with second gear wheel 10 in pitch point 12. Spark plug 7 then ignites the air/fuel mixture.

The energy released in the fuel combustion is applied to piston 2, propelling it toward the bottom dead centre. When piston 2 moves in the top dead centre, the angular velocity of first gear wheel 9 is approximately half of the angular velocity of second gear wheel 10 because the ratio of the distance between pitch point 12 and axis of rotation 14 of first gear wheel 9 to the distance between pitch point 12 and axis of rotation 15 of second gear wheel 10 is close to 2.0. That increases the time piston 2 spends in the top dead centre, which ensures complete combustion of the fuel.

Propelled down by the pressure of incandescent gases, piston 2 creates high pressure in crank chamber 5. Said pressure leads to the closing of valve 20, which prevents the air/fuel mixture from escaping through intake port 19

When piston 2 approaches the bottom dead centre, exhaust port 22 opens and releases exhaust gases into the air, thereby lowering the pressure in cylinder 1. As it moves, piston 2 opens admission port 21, and the compressed air-and-fuel mixture from crank chamber 5 transports into cylinder 1, thus draining said cylinder from the remaining exhaust gases.

When piston 2 progresses from the mid-stroke to the bottom dead centre, the angular velocity of first gear wheel 9 is reduced to approximately half of the angular velocity of second gear wheel 10, because the ratio of the distance between pitch point 13 and axis of rotation 14 of first gear wheel 9 to the distance between pitch point 13 and axis of rotation 15 of second gear wheel 10 in the bottom dead centre is about 2.0. Thus, the time piston 2 spends in the bottom dead centre increases, which favorably impacts the exhaust of gases and charging of cylinder 1 with the air/fuel mixture.

The cycle is now completed, and a new cycle begins.

The claimed design can also be used in four-stroke engines as well as other types of piston internal combustion engines.

The internal combustion engine of the present invention is more efficient than the prototype due to the reduced angular velocity of the crankshaft during the piston's position in the bottom and top dead centres and increased angular velocity of the crankshaft during the piston's position in mid-stroke

Efficiency of the claimed internal combustion engine is also achieved by increasing the torque on the crankshaft at the end of a compression stroke, which reduces the flywheel's inertia mass, lowers the minimum threshold of the internal combustion engine's idle rpm, and/or, if necessary, increases the compression level of the air/fuel mixture

The present invention is realized on general-purpose equipment widely used in industry.

We claim:

1. An internal combustion engine comprising a cylinder, a piston arranged therein and attached to a connecting rod, and a crankshaft; wherein said engine comprises two non-circular gear wheels, wherein the first gear wheel is rigidly fixed on the crankshaft, and the second gear wheel, engageable with the first gear wheel, is rigidly fixed on an additional shaft in such a way that when the crankshaft's positions correspond to the piston's position at the top and bottom dead centres, the distance between the pitch points of the first and second gear wheels and the rotation axis of the first gear wheel is 1.1-5 of the distance between these pitch points and the rotation axis of the second gear wheel; while, when the crankshaft's positions correspond to the piston's mid-stroke, the distance between the pitch points of the first and second gear wheels and the rotation axis of the first gear wheel is 0.2-0.9 of the distance between these pitch points and the rotation axis of the second gear

2. The internal combustion engine of claim 1, wherein the non-circular gear wheels are elliptical.

3. The internal combustion engine of claim 1, wherein the non-circular gear wheels are oval.
